(19) United States
(12) Patent Application Publication
(10) Pub. No.: US 2011/0015767 A1
(43) Pub. Date: Jan. 20, 2011

(54) DOUBLING OR REPLACING A RECORDED SOUND USING A DIGITAL AUDIO WORKSTATION

(75) Inventors: Clemens Homburg, Hamburg (DE); Robert Hunt, San Jose, CA (US); Thorsten Adam, Hamburg (DE)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/506,135

(22) Filed: Jul. 20, 2009

(51) Int. Cl. G06F 17/00

(52) U.S. Cl. 700/94

(57) ABSTRACT

A computer implemented method allows a user to double or replace a recorded sound using a digital audio workstation. The method includes analyzing an audio file for transients. The method includes detecting a sound event with a corresponding timestamp in the audio file. The method then allows generating, by the processor, MIDI data associated with the corresponding timestamp of the detected sound event. The method then allows outputting the MIDI data to a MIDI instrument. Then the MIDI instrument can generate a corresponding sound at the corresponding timestamp in response to receiving the MIDI data. The detected sound event and corresponding sound can be a snare, drum kick, tom, or other percussion sound.

### FIELD

The following relates to computing devices capable of and methods for arranging music, and more particularly to approaches for doubling or replacing or replacing a sound using a digital audio workstation (DAW).

### BACKGROUND

Artists can use software to create musical arrangements. This software can be implemented on a computer to allow an artist to write, record, edit, and mix musical arrangements. Typically, such software can allow the artist to arrange files on musical tracks in a musical arrangement. A computer that includes the software can be referred to as a digital audio workstation (DAW). The DAW can display a graphical user interface (GUI) to allow a user to manipulate files on tracks. The DAW can display each element of a musical arrangement, such as a guitar, microphone, or drums, on separate tracks. For example, a user may create a musical arrangement with a guitar on a first track, a piano on a second track, and vocals on a third track. The DAW can further break down an instrument into multiple tracks. For example, a drum kit can be broken into multiple tracks with the snare, kick drum, and hi-hat each having its own track. By placing each element on a separate track a user is able to manipulate a single track, without affecting the other tracks. For example, a user can adjust the volume or pan of the guitar track, without affecting the piano track or vocal track. As will be appreciated by those of ordinary skill in the art, using the GUI, a user can apply different effects to a track within a musical arrangement. For example, volume, pan, compression, distortion, equalization, delay, and reverb are some of the effects that can be applied to a track.

Typically, a DAW works with two main types of files: MIDI (Musical Instrument Digital Interface) files and audio files. MIDI is an industry-standard protocol that enables electronic musical instruments, such as keyboard controllers, computers, and other electronic equipment, to communicate, control, and synchronize with each other. MIDI does not transmit an audio signal or media, but rather transmits “event messages” such as the pitch and intensity of musical notes to play, control signals for parameters such as volume, vibrato and panning, cues, and clock signals to set the tempo. As an electronic protocol, MIDI is notable for its widespread adoption throughout the industry.

Using a MIDI controller coupled to a computer, a user can record MIDI data into a MIDI track. Using the DAW, the user can select a MIDI instrument that is internal to a computer and/or an external MIDI instrument to generate sounds corresponding to the MIDI data of a MIDI track. The selected MIDI instrument can receive the MIDI data from the MIDI track and generate sounds corresponding to the MIDI data which can be produced by one or more monitors or speakers. For example, a user may select a piano software instrument on the computer to generate piano sounds and/or may select a tenor saxophone instrument on an external MIDI device to generate saxophone sounds corresponding to the MIDI data. If MIDI data from a track is sent to an internal software instrument, this track can be referred to as an internal track. If MIDI data from a track is sent to an external software instrument, this track can be referred to as an external track.

Audio files are recorded sounds. An audio file can be created by recording sound directly into the system. For example, a user may use a guitar to record directly onto a guitar track or record vocals, using a microphone, directly onto a vocal track. As will be appreciated by those of ordinary skill in the art, audio files can be imported into a musical arrangement. For example, many companies professionally produce audio files for incorporation into musical arrangements. In another example, audio files can be downloaded from the Internet. Audio files can include guitar riffs, drum loops, and any other recorded sounds. Audio files can be in sound digital file formats such as WAV, MP3, M4A, and AIFF. Audio files can also be recorded from analog sources, including, but not limited to, tapes and records.

As described above, a user can record various parts of a drum kit onto one or more separate tracks in a digital audio workstation. However, the user is then limited in the recording to the equipment used and circumstances surrounding the recording. For example, as described above, a user may record a drum kit into multiple tracks with the snare, kick drum, and hi-hat each having its own track. However, in a conventional DAW, the sound of the kick drum, cannot easily be changed to another type of kick drum. Similarly, the sound of the originally recorded snare hits cannot easily be doubled or replaced.

A conventional DAW does not allow a user to enhance or “fatten up” a kick drum sound by supplementing the recorded sound with another sound, such as a Roland TR-808 kick. Similarly, conventional DAWs do not allow a user to record a drum kit into a digital audio workstation but then enhance a detected snare drum sound by supplementing the detected sound with another snare sound. Additionally, a conventional DAW does not allow a user to supplement a recorded drum sound with a corresponding sound and automatically mute the original recorded drum sound upon playback, effectively replacing the original drum sound.

### SUMMARY

A computer implemented method allows a user to double or replace a recorded sound using a digital audio workstation. The method includes the DAW analyzing an audio file for transients and detecting a sound event in the audio file, where the sound event has a corresponding timestamp. The DAW then generates MIDI data associated with the corresponding timestamp of the detected sound event. The DAW then outputs the MIDI data to a MIDI instrument, where the MIDI instrument generates a corresponding sound at the corresponding timestamp in response to receiving the MIDI data.

Many other aspects and examples will become apparent from the following disclosure.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system having a DAW musical arrangement in accordance with an exemplary embodiment;

FIG. 2 depicts a screenshot of a GUI of a DAW displaying a musical arrangement including MIDI and audio tracks in accordance with an exemplary embodiment;

FIG. 3A depicts a screenshot of a GUI of a DAW displaying a musical arrangement including MIDI and audio tracks in which a drum doubler MIDI track has been configured to receive MIDI data generated by the DAW in response to detected sound events on an audio track;

FIG. 3B depicts a screenshot of a GUI of a DAW displaying a musical arrangement including MIDI and audio tracks in which a drum doubler MIDI track has received MIDI data generated by the DAW in response to detected sound events on an audio track;

FIG. 4A depicts a screenshot of a GUI of a DAW displaying a musical arrangement including MIDI and audio tracks in which a drum replacer MIDI track has been configured to receive MIDI data generated by the DAW in response to detected sound events on an audio track;

FIG. 4B depicts a screenshot of a GUI of a DAW displaying a musical arrangement including MIDI and audio tracks in which a drum replacer MIDI track has received MIDI data generated by the DAW in response to detected sound events on an audio track; and

FIG. 5 illustrates a flow chart of a method for doubling or replacing a recorded sound in accordance with an exemplary embodiment.

### DETAILED DESCRIPTION

The functions described as being performed at various components can be performed at other components, and the various components can be combined and/or separated. Other modifications also can be made.

Thus, the following disclosure ultimately will describe systems, computer readable media, devices, and methods for doubling or replacing a recorded sound in a digital audio workstation. Many other examples and other characteristics will become apparent from the following description.

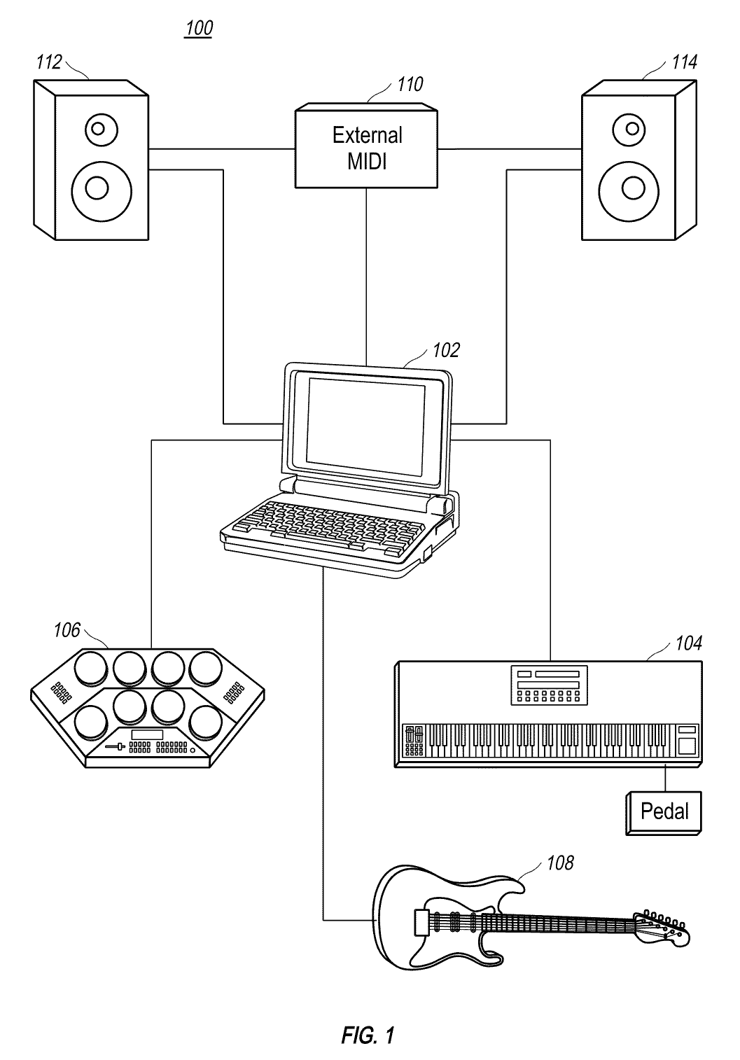

Referring to FIG. 1, a block diagram of a system including a DAW in accordance with an exemplary embodiment is illustrated. As shown, the system 100 can include a computer 102, one or more sound output devices 112, 114, one or more MIDI controllers (e.g. a MIDI keyboard 104 and/or a drum pad MIDI controller 106), one or more instruments (e.g. a guitar 108, and/or a microphone (not shown)), and/or one or more external MIDI devices 110. As would be appreciated by one of ordinary skill in the art, the musical arrangement can include more or less equipment as well as different musical instruments.

The computer 102 can be a data processing system suitable for storing and/or executing program code, e.g., the software to operate the GUI which together can be referred to as a DAW. The computer 102 can include at least one processor, e.g., a processor, coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters. In one or more embodiments, the computer 102 can be a desktop computer or a laptop computer.

A MIDI controller is a device capable of generating and sending MIDI data. The MIDI controller can be coupled to and send MIDI data to the computer 102. The MIDI controller can also include various controls, such as slides and knobs, that can be assigned to various functions within the DAW. For example, a knob may be assigned to control the pan on a first track. Also, a slider can be assigned to control the volume on a second track. Various functions within the DAW can be assigned to a MIDI controller in this manner. The MIDI controller can also include a sustain pedal and/or an expression pedal. These can affect how a MIDI instrument plays MIDI data. For example, holding down a sustain pedal while recording MIDI data can cause an elongation of the length of the sound played if a piano software instrument has been selected for that MIDI track.

As shown in FIG. 1, the system 100 can include a MIDI keyboard 104 and/or a drum pad controller 106. The MIDI keyboard 104 can generate MIDI data which can be provided to a device that generates sounds based on the received MIDI data. The drum pad MIDI controller 106 can also generate MIDI data and send this data to a capable device which generates sounds based on the received MIDI data. The MIDI keyboard 104 can include piano style keys, as shown. The drum pad MIDI controller 106 can include rubber pads. The rubber pads can be touch and pressure sensitive. Upon hitting or pressing a rubber pad, or pressing a key, the MIDI controller (104,106) generates and sends MIDI data to the computer 102.

An instrument capable of generating electronic audio signals can be coupled to the computer 102. For example, as shown in FIG. 1, an electrical output of an electric guitar 108 can be coupled to an audio input on the computer 102. Similarly, an acoustic guitar 108 equipped with an electrical output can be coupled to an audio input on the computer 102. In another example, if an acoustic guitar 108 does not have an electrical output, a microphone positioned near the guitar 108 can provide an electrical output that can be coupled with an audio input on the computer 102. The output of the guitar 108 can be coupled to a pre-amplifier (not shown) with the pre-amplifier being coupled to the computer 102. The pre-amplifier can boost the electronic signal output of the guitar 108 to acceptable operating levels for the audio input of computer 102. If the DAW is in a record mode, a user can play the guitar 108 to generate an audio file. Popular effects such as chorus, reverb, and distortion can be applied to this audio file when recording and playing.

The external MIDI device 110 can be coupled to the computer 102. The external MIDI device 110 can include a processor, e.g., an external processor which is external to the processor. The external processor can receive MIDI data from an external MIDI track of a musical arrangement to generate corresponding sounds. A user can utilize such an external MIDI device 110 to expand the quality and/or quantity of available software instruments. For example, a user may configure the external MIDI device 110 to generate electric piano sounds in response to received MIDI data from a corresponding external MIDI track in a musical arrangement from the computer 102.

The computer 102 and/or the external MIDI device 110 can be coupled to one or more sound output devices (e.g., monitors or speakers). For example, as shown in FIG. 1, the computer 102 and the external MIDI device 110 can be coupled to a left monitor 112 and a right monitor 114. In one or more embodiments, an intermediate audio mixer (not shown) may be coupled between the computer 102, or external MIDI device 110, and the sound output devices, e.g., the monitors 112, 114. The intermediate audio mixer can allow a user to adjust the volume of the signals sent to the one or more sound output devices for sound balance control. In other embodiments, one or more devices capable of generating an audio signal can be coupled to the sound output devices 112, 114. For example, a user can couple the output from the guitar 108 to the sound output devices.

The one or more sound output devices can generate sounds corresponding to the one or more audio signals sent to them. The audio signals can be sent to the monitors 112, 114 which can require the use of an amplifier to adjust the audio signals to acceptable levels for sound generation by the monitors 112, 114. The amplifier in this example may be internal or external to the monitors 112, 114.

Although, in this example, a sound card is internal to the computer 102, many circumstances exist where a user can utilize an external sound card (not shown) for sending and receiving audio data to the computer 102. A user can use an external sound card in this manner to expand the number of available inputs and outputs. For example, if a user wishes to record a band live, an external sound card can provide eight (8) or more separate inputs, so that each instrument and vocal can each be recorded onto a separate track in real time. Also, disc jockeys (djs) may wish to utilize an external sound card for multiple outputs so that the dj can cross-fade to different outputs during a performance.

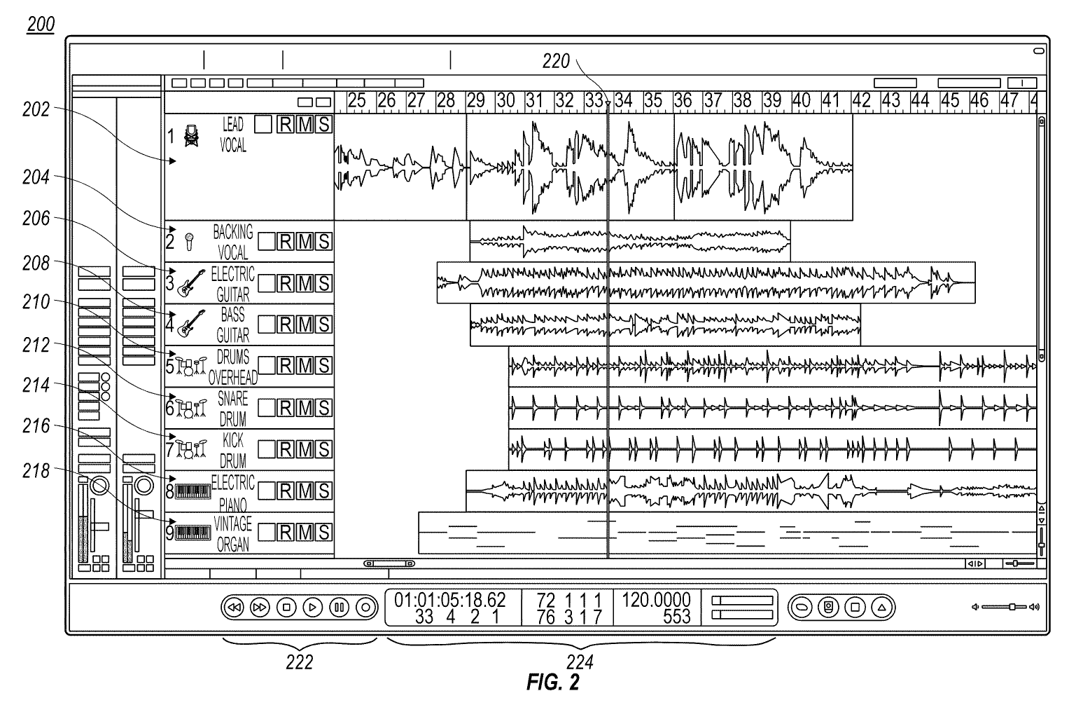

Referring to FIG. 2, a screenshot of a musical arrangement in a GUI of a DAW in accordance with an exemplary embodiment is illustrated. The musical arrangement 200 can include one or more tracks with each track having one or more of audio files or MIDI files. Generally, each track can hold audio or MIDI files corresponding to each individual desired instrument. As shown, the tracks are positioned horizontally. A playhead 220 moves from left to right as the musical arrangement is recorded or played. As one of ordinary skill in the art would appreciate, other tracks and playhead 220 can be displayed and/or moved in different manners. The playhead 220 moves along a timeline that shows the position of the playhead within the musical arrangement. The timeline indicates bars, which can be in beat increments. For example as shown, a four (4) beat increment in a 4/4 time signature is displayed on a timeline with the playhead 220 positioned between the thirty-third (33rd) and thirty-fourth (34th) bar of this musical arrangement. A transport bar 222 can be displayed and can include commands for playing, stopping, pausing, rewinding and fast-forwarding the displayed musical arrangement. For example, radio buttons can be used for each command. If a user were to select the play button on transport bar 222, the playhead 220 would begin to move down the timeline, e.g., in a left to right fashion.

As shown, the lead vocal track, 202, is an audio track. One or more audio files corresponding to a lead vocal part of the musical arrangement can be located on this track. In this example, a user has directly recorded audio into the DAW on the lead vocal track. The backing vocal track, 204 is also an audio track. The backing vocal 204 can contain one or more audio files having backing vocals in this musical arrangement. The electric guitar track 206 can contain one or more electric guitar audio files. The bass guitar track 208 can contain one or more bass guitar audio files within the musical arrangement. The drum kit overhead track 210, snare track 212, and kick track 214 relate to a drum kit recording. An overhead microphone can record the cymbals, hit-hat, cow bell, and any other equipment of the drum kit on the drum kit overhead track. The snare track 212 can contain one or more audio files of recorded snare hits for the musical arrangement. Similarly, the kick track 214, can contain one or more audio files of recorded bass kick hits for the musical arrangement. The electric piano track 216 can contain one or more audio files of a recorded electric piano for the musical arrangement.

The vintage organ track 218 is a MIDI track. Those of ordinary skill in the art will appreciate that the contents of the files in the vintage organ track 218 can be shown differently because the track contains MIDI data and not audio data. In this example, the user has selected an internal software instrument, a vintage organ, to output sounds corresponding to the MIDI data contained within this track 218. A user can change the software instrument, for example to a trumpet, without changing any of the MIDI data in track 218. Upon playing the musical arrangement the trumpet sounds would now be played corresponding to the MIDI data of track 218. Also, a user can set up track 218 to send its MIDI data to an external MIDI instrument, as described above.

Each of the displayed audio and MIDI files in the musical arrangement as shown on screen 200 can be altered using the GUI. For example, a user can cut, copy, paste, or move an audio file or MIDI file on a track so that it plays at a different position in the musical arrangement. Additionally, a user can loop an audio file or MIDI file so that it is repeated, split an audio file or MIDI file at a given position, and/or individually time stretch an audio file for tempo, tempo and pitch, and/or tuning adjustments as described below.

Display window 224 contains information for the user about the displayed musical arrangement. As shown, the current tempo in bpm of the musical arrangement is set to 120 bpm. The position of playhead 220 is shown to be at the thirty-third (33rd) bar beat four (4) in the display window 224. Also, the position of the playhead 220 within the song is shown in minutes, seconds etc.

Tempo changes to a musical arrangement can affect MIDI tracks and audio tracks differently. In MIDI files, tempo and pitch can be adjusted independently of each other. For example, a MIDI track recorded at 100 bpm (beats per minute) can be adjusted to 120 bpm without affecting the pitch of the samples played by the MIDI data. This occurs because the same samples are being triggered by the MIDI data, they are just being triggered faster in time. In order to change the tempo of the MIDI file, the signal clock of the relevant MIDI data is changed. However, tempo changes to an audio file inherently adjust the pitch of the file as well. For example, if an audio file is sped up, the pitch of the sound goes up. Similarly, if an audio file is slowed, the pitch of the sound goes down.

In regards to digital audio files, one way that a DAW can change the duration of an audio file to match a new tempo is to resample it. This is a mathematical operation that effectively rebuilds a continuous waveform from its samples and then samples that waveform again at a different rate. When the new samples are played at the original sampling frequency, the audio clip sounds faster or slower. In this method, the frequencies in the sample are scaled at the same rate as the speed, transposing its perceived pitch up or down in the process. In other words, slowing down the recording lowers the pitch, speeding it up raises the pitch.

A DAW can use a process known as time stretching to adjust the tempo of audio while maintaining the original pitch. This process requires analysis and processing of the original audio file. Those of ordinary skill in the art will recognize that various algorithms and methods for adjusting the tempo of audio files while maintaining a consistent pitch can be used.

One way that a DAW can stretch the length of an audio file without affecting the pitch is to utilize a phase vocoder. The first step in time-stretching an audio file using this method is to compute the instantaneous frequency/amplitude relationship of the audio file using the Short-Time Fourier Transform (STFT), which is the discrete Fourier transform of a short, overlapping and smoothly windowed block of samples. The next step is to apply some processing to the Fourier transform magnitudes and phases (like resampling the FFT blocks). The third step is to perform an inverse STFT by taking the inverse Fourier transform on each chunk and adding the resulting waveform chunks.

The phase vocoder technique can also be used to perform pitch shifting, chorusing, timbre manipulation, harmonizing, and other modifications, all of which can be changed as a function of time.

Another method that can be used for time shifting audio regions is known as time domain harmonic scaling. This method operates by attempting to find the period (or equivalently the fundamental frequency) of a given section of the audio file using a pitch detection algorithm (commonly the peak of the audio file's autocorrelation, or sometimes cepstral processing), and crossfade one period into another.

The DAW can combine the two techniques (for example by separating the signal into sinusoid and transient waveforms), or use other techniques based on the wavelet transform, or artificial neural network processing, for example, for time stretching. Those of ordinary skill in the art will recognize that various algorithms and combinations thereof for time stretching audio files based on the content of the audio files and desired output can be used by the DAW.

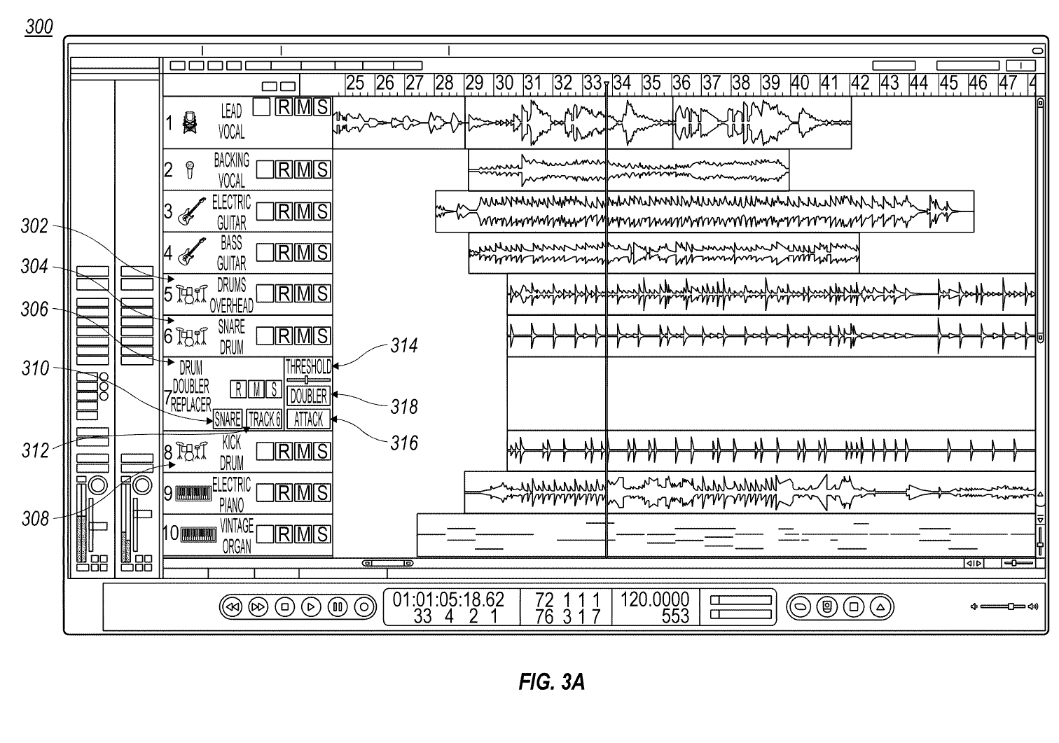

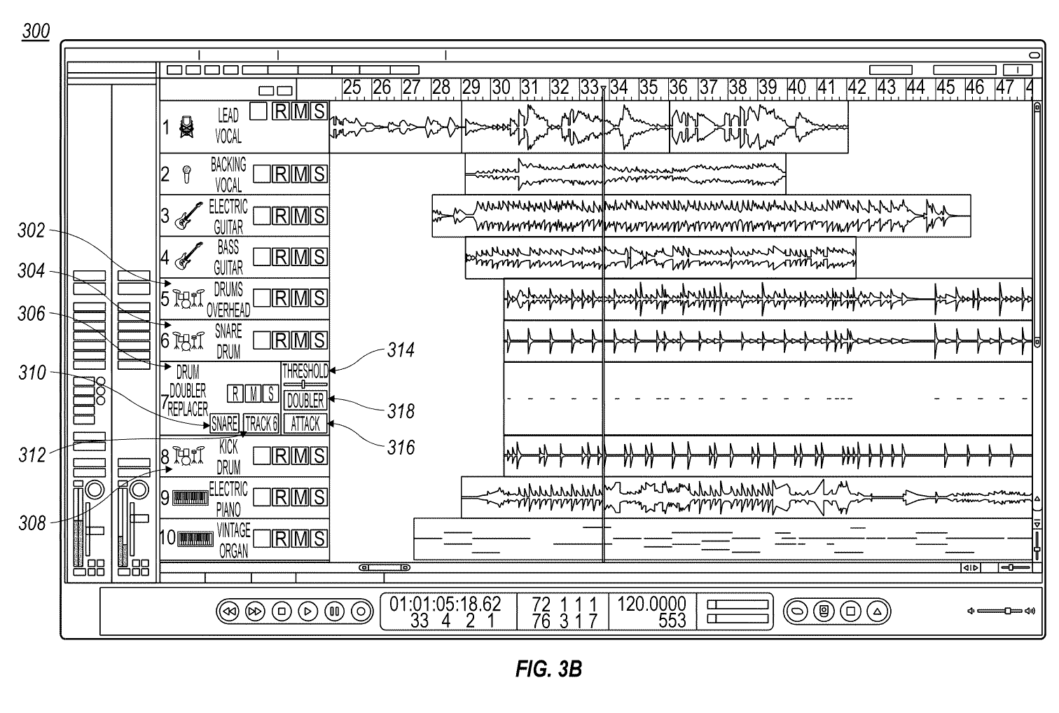

FIG. 3A illustrates a screenshot 300 of a GUI of a DAW displaying a musical arrangement including MIDI and audio tracks. Screenshot 300 is substantially similar to the screenshot 200 in FIG. 2, except a user has added a MIDI track to the arrangement and designated this new MIDI track as a Drum Doubler/Replacer track. The Drum Doubler/Replacer MIDI track has been configured to receive MIDI data generated by the DAW in response to detected sound events in an audio file.

This new Drum Doubler/Replacer MIDI track can be created by the DAW in response to receiving a command. For example, a user can click a “New Track” button and then click “MIDI track” followed by “Drum Doubler/Replacer” in a GUI (not shown).

A Doubler/Replacer MIDI track can include a pull-down menu to allow a user to designate an audio track in an arrangement for event detection. A pull-down menu can be positioned within a combo box. A Doubler/Replacer MIDI track can also include a pull-down menu to allow a user designate a corresponding sound to be generated. Furthermore, a Doubler/Replacer MIDI track can include a pull-down menu to allow a user to choose a Double or Replace mode. A Doubler/Replacer MIDI can also include a slider to allow a user to adjust a threshold and a button to enter an attack time for detected events in an audio file. These examples are described in more detail below. Those of ordinary skill in the art would recognize that other interface elements can be implemented to enter and adjust these settings.

In one example, the DAW can analyze the audio file chosen for event detection for transients in this audio file. A transient is a short-duration signal that represents a non-harmonic attack phase of a musical sound. Analyzing the audio file for transients allows the DAW to separate sounds events. This analysis of the audio file can occur at any point prior to detecting sound events in the audio file. Those of ordinary skill in the art would recognize that various algorithms and timing can be implemented to analyze transients in an audio file for sound event detection

Returning to FIG. 3A, a Drums Overhead audio track 302, a Snare Drum audio track 304, and a Kick Drum audio track 308 are displayed in screenshot 300. Also, as shown, a Drum Doubler/Replacer track 306 is displayed in screenshot 300. The Drum Doubler/Replacer track 306, in this example, includes various pull-down menus, buttons, and a slider. The DAW including the Drum Doubler/Replacer track allows a user to designate an input track, for detecting sound events with a pull-down menu 312. In this example, the Drum Doubler/Replacer track 306 will detect sound events on an audio file on Track 6, which is the Snare Drum audio track 304 of the displayed musical arrangement.

The Drum Doubler/Replacer allows a user to designate a corresponding sound to be associated with generated MIDI data in response to detected sound events by use of a pull-down menu 310. In this example, the Drum Doubler/Replacer track 306 will associate a snare sound as the corresponding sound in the generated MIDI data. Additionally, the Drum Doubler/Replacer can allow a user to designate a double or replace mode by the user of a pull-down menu 318. The replace mode will be explained in more detail below. In this example, a user has designated a double mode.

FIG. 3B illustrates the screenshot 300 of FIG. 3A displaying a musical arrangement including MIDI and audio tracks, however now the Drum Doubler/Replacer MIDI track has received MIDI data generated by the DAW in response to detected sound events on track 6. As shown, the DAW has generated MIDI data associated with a corresponding snare sound at the corresponding timestamp of each detected event in Snare Drum track 304. Upon playing the entire musical arrangement, the DAW will output the detected snare sounds on Snare Drum track 304 and corresponding Snare sounds associated with the MIDI data on Drum Doubler/Replacer track 306 at or about the same time.

In this example, the generated MIDI data in response to the detected sound events can include association with MIDI note D1 (38). In a General MIDI Instrument implementation, associating MIDI note D1 (38) with the MIDI data generated into detected sound events on Snare Drum track 304, will cause the DAW to output snare sounds as described above.

The Drum Doubler/Replacer can allow a user to adjust a threshold (in decibels), by a slider 314, that a sound event must exceed in order for the DAW to consider a sound event a detected sound event. If a user adjusts the threshold level a command can be sent, and the DAW will re-analyze the Snare Drum Track 304, in response to the received adjustment command, for transients and detect sound events that exceed the newly set threshold. In this example, the DAW will then generate MIDI data at the corresponding time stamp of the newly detected sound events. This re-analysis can occur at other times and by other commands. The threshold adjustment can be in the range of −40.0 to 0.0 dB, in 0.5 dB increments, with a default value of −12.0 dB.

The Drum Doubler/Replacer can allow a user to adjust an average attack level that a sound event must exceed in order for the DAW to consider a sound event a detected sound event, for example by a pull-down menu 316. Attack is how quickly a sound reaches full volume after the sound is activated. If a user adjusts the attack level a command can be sent, and the DAW will re-analyze the Snare Drum Track 304 for transients and detect sound events that correspond to the newly set average attack in response to the received adjustment command. In this example, the DAW will then generate MIDI data at the corresponding time stamp of the newly detected sound events.

Additionally, the GUI can allow a user to adjust the timing (not shown) of the generated MIDI data on Drum Doubler/Replacer Track 306. The GUI can allow a user to shift the MIDI data right or left, by a time increment, such as milliseconds, in order to fine-tune the alignment of each detected sound event and its corresponding generated MIDI data.

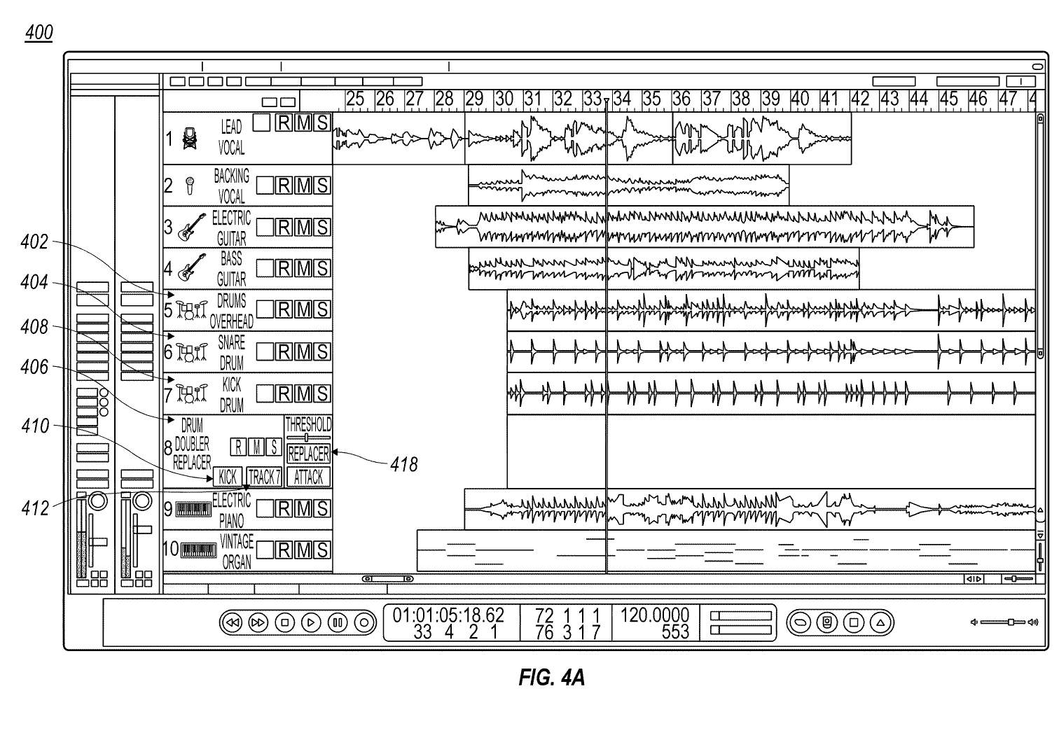

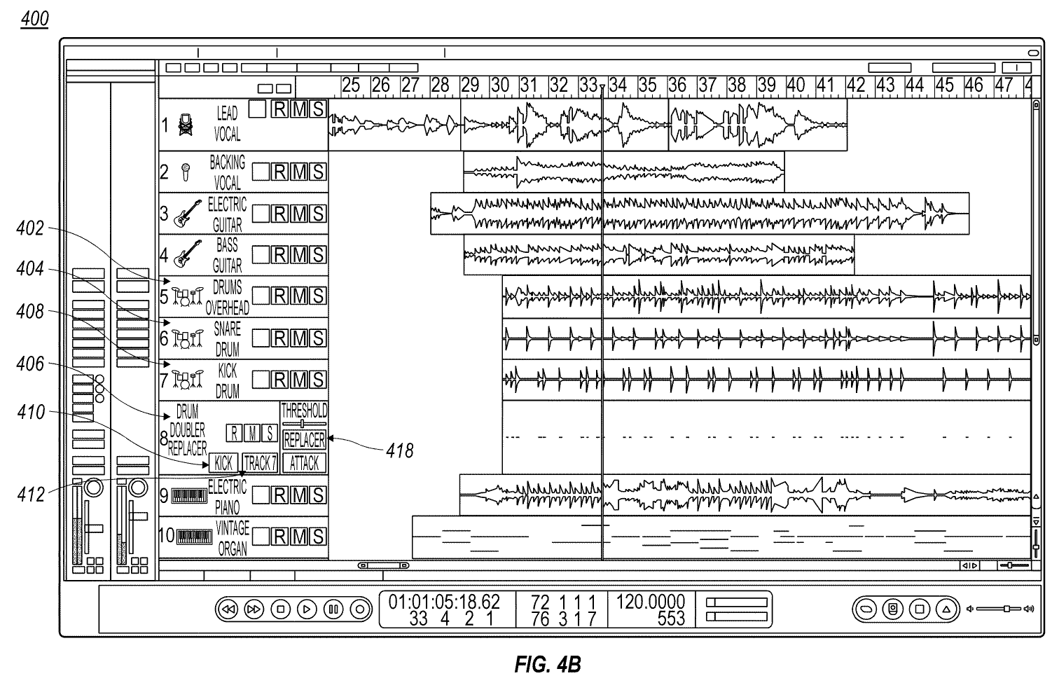

FIG. 4A is substantially similar, to FIG. 3A, however in FIG. 4A a user has created a Drum Replacer MIDI track. FIG. 4A illustrates a screenshot 400 of a GUI of a DAW displaying a musical arrangement including MIDI and audio tracks in which a Drum Replacer MIDI track has been configured to receive MIDI data generated by the DAW in response to detected sound events. A Drums Overhead audio track 402, a Snare Drum audio track 404, and a Kick Drum audio track 408 are displayed in screenshot 400. Also, as shown, a Drum Doubler/Replacer track 406 is displayed in screenshot 400. The Doubler/Replacer track 406 can allow a user to designate an input track, for detecting sound events, by a pull-down menu 412. In this example, the Drum Doubler/Replacer track 406 will detect sound events on an audio file on Track 7, which is the Kick Drum audio track 408 of the displayed musical arrangement.

The Drum Doubler/Replacer allows a user to designate a corresponding sound 410 to be associated with generated MIDI data in response to detected sound events by a pull-down menu. In this example, the Drum Doubler/Replacer track 406 will associate a Kick Drum sound as the corresponding sound in the generated MIDI data.

In this example, the generated MIDI data in response to the detected sound events can include association with MIDI note C1 (36). In a General MIDI Instrument implementation, associating MIDI note C1 (36) with the MIDI data generated into detected sound events on Kick Drum track 408, will cause the DAW to output corresponding Kick Drum sounds.

As described above, the Drum Doubler/Replacer can allow a user to designate a double or replace mode by the user of a pull-down menu. In this example, a user has designated a replace mode 418. The replace mode can cause the DAW to automatically mute Kick Drum audio track 408 upon playback, and the DAW will only generate the corresponding Kick Drum sounds related to the MIDI data on Drum Doubler/Replacer track 406, resulting in replacement of the detected events on Kick Drum audio track 408.

FIG. 4B illustrates the screenshot 400 of a GUI of a DAW displaying a musical arrangement including MIDI and audio tracks. Now, however, Drum Doubler/Replacer MIDI track 406 has received MIDI data generated by the DAW in response to detected sound events on Kick Drum audio track 408. As shown, the DAW has generated MIDI data associated with a corresponding kick drum sound at the corresponding timestamp of each detected event in Kick Drum track 408.

Upon playing the entire musical arrangement, the DAW will automatically mute the detected snare sounds on Kick Drum track 408 but generate the corresponding Snare sounds associated with the MIDI data on Drum Doubler/Replacer track 406. The DAW can automatically mute the detected snare sounds on Kick Drum track 408 by muting the entire Kick Drum track 408 during playback, as shown in FIG. 4B.

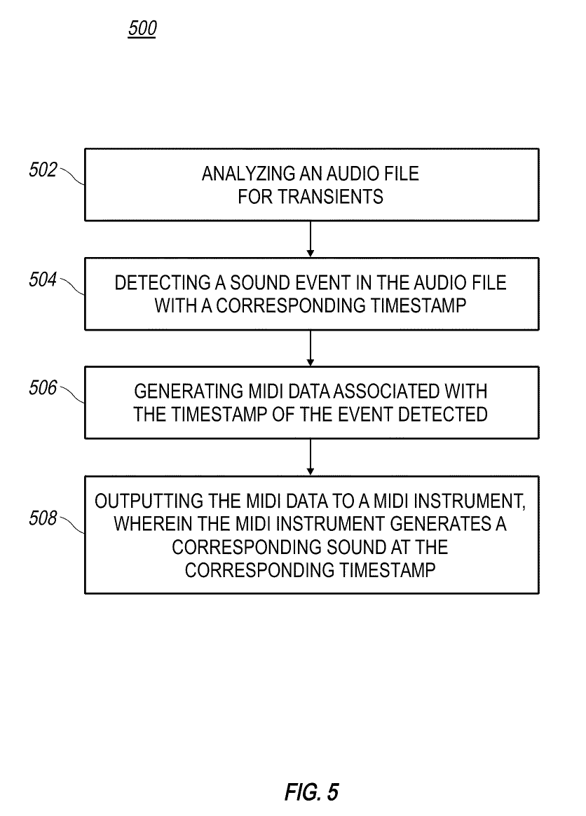

Referring to FIG. 5, a flow chart of a method for doubling or replacing a recording sound in accordance with an exemplary embodiment is illustrated. The exemplary method 500 is provided by way of example, as there are a variety of ways to carry out the method. In one or more embodiments, the method 500 is performed by the computer 102 of FIG. 1. The method 500 can be executed or otherwise performed by one or a combination of various systems. The method 500 described below can be carried out using the devices illustrated in FIG. 1 by way of example, and various elements of this Figure are referenced in explaining exemplary method 500. Each block shown in FIG. 5 represents one or more processes, methods or subroutines carried out in exemplary method 500. The exemplary method 500 can begin at block 502.

At block 502, an audio file is analyzed for transients. For example, the computer 102, e.g., a processor, analyzes an audio file in an arrangement of a DAW for transients. In another example, a processor module residing on a computer-readable medium can analyze an audio file for transients. After analyzing the audio file for transients, the method 500 can proceed to block 504.

At block 504, a sound event with a corresponding timestamp is detected. For example, the processor or the processor module can display a GUI to allow a user to engage the DAW to detect sound events in a track, as shown in FIG. 3B. In this figure, a user has created a Drum Double or Replacer Track 306. Furthermore, in this figure a user has selected that the Drum Double or Replacer Track 306 detect sound events in an audio file on a Track 6, i.e. the Snare Drum Track 304. In this figure, a user has designated a corresponding snare sound 310 to be associated with MIDI data generated in response to detected sound events on Snare Drum Track 304.

A user can now adjust the threshold for detected sound events by activating the threshold slider on the GUI of FIG. 3B. The processor or processor module can detect a sound event when the sound event exceeds a specified threshold. Those of ordinary skill in the art will appreciate that other GUIs can be implemented to allow for threshold adjustment. A user can also adjust the attack for detected sound events by activating the attack button on the GUI of FIG. 3B. The processor or processor module can display the GUIs as shown on FIG. 3B. The processor or processor module can adjust the threshold in response to receiving a command.

Returning to FIG. 5, at block 506, MIDI data associated with the timestamp of the detected event is generated. For example, the processor can generate MIDI data or the processor module can generate MIDI data associated with a kick, snare, tom, or other percussion instrument.

For example, the processor or the processor module can display generated MIDI data associated with the timestamp of a detected event, as shown in FIG. 3B. In this figure the DAW has generated MIDI data associated with a snare sound 310 in response to detected sound events on Snare Drum Track 304. In another example, the processor or the processor module can display generated MIDI data associated with the timestamp of a detected event, as shown in FIG. 4B. In this figure the DAW has generated MIDI data associated with a kick drum sound 410 in response to detected sound events on Kick Drum Track 408.

At block 508, the DAW can output the generated MIDI data to a MIDI instrument. The MIDI instrument can then generate a corresponding sound at the corresponding time stamp. For example, the processor can output the generated MIDI data to a MIDI instrument. In another example, the processing module can output the generated MIDI data to a MIDI instrument.

In one example, the processor can generate the corresponding sound. In another example, the outputting module can output the corresponding sound. In the event the MIDI instrument is an external MIDI instrument, an external processor or an external processor module can generate the corresponding sound.

The processor or a processor module can display a GUI to allow a user to instruct the DAW to suppress the detected sound event upon playback. In this example, the corresponding sound can replace the suppressed detected sound event, resulting in sound replacement instead of doubling or replacing.

Conversely, the processor or a processor module can display a GUI to allow a user to instruct the DAW to output the detected sound event and the corresponding sound upon playback, at or about the same time.

The processor or the outputting module can generate a corresponding sound associated with a kick, snare, tom, or other percussion instrument. In the example of an external MIDI instrument, the external processor or the second outputting module can generate a corresponding sound associate with a kick, snare, tom, or other percussion instrument.

For example, the processor or the processor module can display a GUI to allow a user to engage a DAW to output a corresponding sound associated with the timestamp of a detected event, as shown in FIG. 3B. In this figure the DAW can utilize a MIDI instrument to output a snare sound 310 in response to detected sound events on Snare Drum Track 304. In another example, the processor or the processor module can display a GUI to allow a user to engage the DAW to output a corresponding kick drum sound associated with the timestamp of a detected event, as shown in FIG. 4B. In this figure the DAW can utilize a MIDI instrument to output a corresponding kick drum sound 410 in response to detected sound events on Kick Drum Track 408.

The technology can take the form of an entirely hardware embodiment, an entirely software embodiment or an embodiment containing both hardware and software elements. In one embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized and/or distributed as known to those skilled in the art.

The above disclosure provides examples and aspects relating to various embodiments within the scope of claims, appended hereto or later added in accordance with applicable law. However, these examples are not limiting as to how any disclosed aspect may be implemented, as those of ordinary skill can apply these disclosures to particular situations in a variety of ways.

We claim:

1. A computer implemented method for doubling or replacing a recorded sound, the method comprising, in a processor:
analyzing an audio file for transients;
detecting a sound event in the audio file, wherein the detected sound event has a corresponding timestamp;
generating MIDI data associated with the corresponding timestamp of the detected sound event; and
outputting the MIDI data to a MIDI instrument wherein the MIDI instrument generates a corresponding sound at the corresponding timestamp in response to receiving the MIDI data.

2. The computer implemented method of claim 1, further comprising outputting the audio file with the detected sound event being suppressed and the corresponding sound replacing the suppressed detected sound event.

3. The computer implemented method of claim 1, further comprising outputting the audio file having the detected sound event, with the detected sound event and the corresponding sound being generated at about the same time.

4. The computer implemented method of claim 1, wherein the corresponding sound is selected from the group consisting of kick, snare, tom, and other percussion instruments.

5. The computer implemented method of claim 1, wherein the sound event is detected in the event the sound event exceeds a specified threshold.

6. The computer implemented method of claim 5, further comprising adjusting the threshold in response to receiving a command.

7. The computer implemented method of claim 1, wherein the detected sound event is one of a sound for a kick, snare, tom, and other percussion instruments.

8. A computer program product for doubling or replacing a recorded sound, the computer program product comprising:
a computer-readable medium;
a processor module residing on the computer-readable medium and operative to:
analyze an audio file for transients;
detect a sound event in the audio file, wherein the detected sound event has a corresponding timestamp; and
generate MIDI data associated with the corresponding timestamp of the detected sound event; and
an outputting module residing on the computer-readable medium and operative to output the MIDI data to a MIDI instrument wherein the MIDI instrument generates a corresponding sound at the corresponding timestamp.

9. The computer program product of claim 8, further comprising the processing module operative to suppress the detected sound event and the outputting module operative to generate the corresponding sound, thereby replacing the suppressed detected sound event.

10. The computer program product of claim 8, further comprising the outputting module outputting the audio file having the detected sound event with the detected sound event and the corresponding sound being generated at about the same time.

11. The computer program product of claim 8, wherein the corresponding sound is one of a sound for a kick, snare, tom, and other percussion instruments.

12. The computer program product of claim 8, wherein the sound event is detected in the event the sound event exceeds a specified threshold.

13. The computer program product of claim 8, wherein the processing module is operative to adjust the threshold in response to receiving a command.

14. The computer program product of claim 8, wherein the detected sound event is one of a sound for a kick, snare, tom, and other percussion instruments.

15. A system for doubling or replacing a recorded sound, the system comprising a processor operative to:
analyze an audio file for transients;
detect a sound event in the audio file, wherein the detected sound event has a corresponding timestamp;
generate MIDI data associated with the corresponding timestamp of the detected sound event; and
output the MIDI data to a MIDI instrument, wherein the MIDI instrument generates a corresponding sound at the corresponding timestamp.

16. The system of claim 15, wherein the processor is further operative to output the audio file with the detected sound event being suppressed and the corresponding sound replacing the suppressed detected sound event.

17. The system of claim 15, wherein the processor is further operative to output the audio file having the detected sound event, with the detected sound event and the corresponding sound at about the same time.

18. The system of claim 15, further comprising memory comprising audio sounds further operative to select the corresponding sound from the group consisting of kick, snare, tom, and other percussion instruments.

19. The system of claim 15, wherein the processor is operative to detect the sound event in the event the sound event exceeds a specified threshold.

20. The system of claim 15, wherein the processor is operative to adjust the threshold in response to receiving a command.

21. The system of claim 15, wherein the detected sound event is one of a sound for a kick, snare, tom, and other percussion instruments.
